(19) United States
(12) Patent Application Publication
(10) Pub. No.: US 2002/0148776 A1
(43) Pub. Date: Oct. 17, 2002

(54) Water filtration media and methods of making same

(76) Inventors: Frank Cousart, Boiling Springs, PA (US); Larry Simon, Newville, PA (US); Dana Walker, Carlisle, PA (US)

Correspondence Address: NIXON & VANDERHYE P.C., 8th Floor, 1100 North Glebe Road, Arlington, VA, 22201, US

(21) Appl. No.: 09/771,934

(22) Filed: Jan. 30, 2001

(51) Int. Cl. B01D 39/20; B29C 71/00; B29C 71/02

(52) U.S. Cl. 210/504; 210/505; 210/509; 264/86; 264/234; 264/237

(57) ABSTRACT

Filtration media is comprised of a mixture of glass and synthetic polymeric fibers. Binder fibers are also preferably incorporated into the mixture of glass and synthetic polymeric fibers so as to achieve a structurally coherent mass of such fibers. Most preferably, a combination of thermoplastic and at least partially water soluble binder fibers will be present in the fibrous filtration media of this invention so as to promote structural integrity during processing and end use applications. In this regard, the fibrous filtration media is preferably made by wet-laying an aqueous slurry mixture of glass fibers and synthetic fibers onto a foraminous forming member (e.g., a forming wire) using conventional Fourdrinier or foam-type fiber wet-laying processes. Thereafter, the slurry mixture is dewatered to form a fibrous dewatered sheet of the glass and synthetic fibers. If present, the binder fibers are physically dispersed in the slurry mixture when laid onto the forming member. The sheet or mat or dewatered fibrous filtration media may then be subjected to elevated temperature so as to at least partially plasticize the thermoplastic binder fibers and thereby bind the glass and synthetic fibers at respective crossing points upon subsequent cooling.

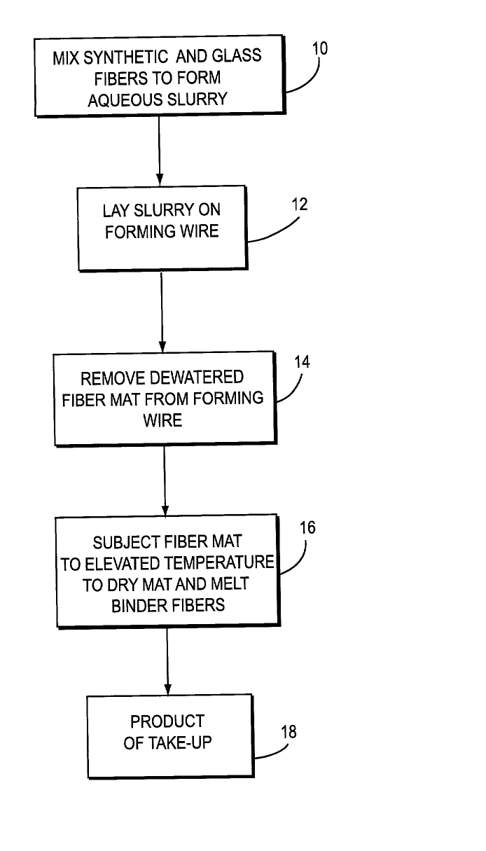

### FIELD OF THE INVENTION

The present invention relates generally to the field of liquid filtration. In preferred forms, the present invention is embodied in water filtration media which include a mass of non-woven synthetic polymeric and glass fibers, and to the methods by which such filtration media are made.

### BACKGROUND AND SUMMARY OF THE INVENTION

It is well known that non-woven mats formed of glass fibers are useful to effectively filter water so as to remove bacterial contamination (i.e., have a minimum filtration efficacy of 4-log reduction of 3-micron spheres, and therefore, cryptosporidia, colloquially known as the “beaver fever” bacterium). However, such glass fiber mats have several inherent deficiencies. For example, glass fiber mats used for water filtration are inherently weak and therefore typically cannot function as water filtration media in and of itself. For this reason, conventional water filtration media are composite structures having glass fiber mats bonded or laminated to a secondary scrim for purpose of increasing the composite's strength characteristics.

The inherent weakness of glass fiber mats also has several disadvantages during lamination to support scrim. For example, it is not unusual for the glass fiber mat to be pulled apart during lamination causing large cracks or voids in the end material. The internal bond strength of the glass fibers is also low and the sheet can thus be easily delaminated by sharp turns during web processing. In addition, the lamination process causes adhesive deposits and adds cost.

Glass fiber mats have other inherent disadvantages. In this regard, glass fibers will typically have “shots” which cause occasional point flaws in the media. Glass fibers are also difficult to disperse and therefore occasional fiber bundles may be present in the media. Glass fibers are also relatively expensive and are difficult to form into a sheet.

It would therefore be highly desirable if a glass fiber-containing mat could be provided which has the requisite water-filtration and physical strength properties to be suitable for use as water filtration media. It is towards providing such a filtration media that the present invention is directed.

Broadly, the present invention is embodied in filtration media which is comprised of a mixture of glass and synthetic polymeric fibers, and to methods of making the same. Most preferably, binder fibers are also incorporated into the mixture of glass and synthetic polymeric fibers so as to achieve a structurally coherent mass of such fibers. Most preferably, the filtration media of the present invention will exhibit a filtration efficacy of at least about 4.0-log reduction, a wet burst strength of at least about 10-inches H₂O, and flow rapidity (2-inch waterhead) of at least about 175 ml/min.

The glass fibers will preferably have an average diameter of between about 0.20 μm to about 0.75 μm, and will be present in the fibrous filtration media in an amount between about 10 wt. % to about 50 wt. % (all weight percentages expressed herein being on the basis of the total dry weight of the fibrous filtration media). The synthetic polymeric fibers will preferably have an average denier of less than about 3.0, and more preferably less than 1.0 and will be present in an amount between about 25 wt. % to about 65 wt. %.

Most preferably, a combination of thermoplastic and at least partially water soluble binder fibers will be present in the fibrous filtration media of this invention. In especially preferred embodiments, the thermoplastic binder fibers are present in an amount between about 10 wt. % to about 15 wt. %, and the at least partially water soluble binder fibers being present in an amount between about 1 wt. % to about 5 wt. %.

The fibrous filtration media is preferably made by wet-laying an aqueous slurry mixture of glass fibers and synthetic fibers onto a foraminous forming member (e.g., a forming wire) using conventional Fourdrinier, inclined wire, or foam-type fiber wet-laying processes. Thereafter, the slurry mixture is dewatered to form a fibrous dewatered sheet of the glass and synthetic fibers. If present, the binder fibers are physically dispersed in the slurry mixture when laid onto the forming member. The sheet or mat or dewatered fibrous filtration media may then be subjected to elevated temperature so as to at least partially plasticize the thermoplastic binder fibers and thereby bind the glass and synthetic fibers at respective crossing points upon subsequent cooling.

These and other aspects and advantages will become more apparent after careful consideration is given to the following detailed description of the preferred exemplary embodiments thereof.

### BRIEF DESCRIPTION OF THE ACCOMPANYING DRAWINGS

Reference will hereinafter be made to the accompanying drawing FIGURE which schematically depicts preferred process steps in forming the filtration media of the present invention.

### DETAILED DESCRIPTION OF THE INVENTION

The present invention most preferably includes a mixture of glass fibers and synthetic polymeric fibers. As used herein and in the accompanying claims, the term “fiber” includes fibrous strands having a relatively short length which is nonetheless substantially in excess of its diameter (i.e., staple fibers). The term “filament”, on the other hand, includes fibers of extreme or indefinite length.

Most preferably, the glass fibers employed in the present invention will have an average diameter of from about 0.20 to about 0.75 μ, and preferably between about 0.25 to about 0.65 μ. The filtration media will most preferably include between about 10 to about 50 wt. % of glass fiber (all weight percentages herein being express based on the total weight of the fibrous filtration media exclusive of any reinforcement scrim that may be present). In this regard, the amount of glass fiber in the filtration media will decrease when either finer diameter glass fibers and/or synthetic fibers are employed.

The glass fibers employed in the practice of the present invention are preferably formed from a borosilicate glass. Other glass chemistries may, however, be employed, if desired (e.g., E-type glass, T-type glass or the like). The glass fibers that may be used in the practice of the invention are commercially available from a number of sources, for example, the 100 Series Micro-Strand® glass fibers commercially available from the Johns Manville Company of Denver, Colo.

The synthetic polymeric fibers may be formed from thermoplastic or thermoset polymeric materials. Most preferably, however, the synthetic polymeric fibers are formed of thermoplastic polymeric materials, for example, polyolefins, polyesters and polyamides (e.g., nylons, including nylon 6, nylon 6,6, nylon 6,12 and the like). The particular synthetic fiber that is employed in the practice of the present invention must, of course, be selected so as to be compatible with the liquid to be filtered. For example, when filtering potable water, the synthetic polymeric materials should be inert to chemicals typically found therein. Specific examples of synthetic polymeric fibers that may be employed in the practice of the present invention include nylon fibers that are commercially available from a number of sources, for example, the nylon 6,6 tow commercially available from Rhodia Performance Fibers of Charleston, S.C.

Most preferably, the synthetic polymer fibers employed in the present invention will have an average denier of less than about 3.0, and more preferably less than about 1.0. Synthetic polymeric fibers of between about 0.1 to about 0.9 denier, suitably about 0.8 denier may be satisfactorily employed. The filtration media will most preferably include between about 25 to about 65 wt. % of the synthetic polymeric fibers, but as noted above, the amount of synthetic polymers may increase with a decrease in the fiber diameter.

The fibrous filtration media of the present invention will also include a binder material. Most preferably, the binder material is in the form of fibers which serve to bind the mixture of staple glass and synthetic polymeric fibers into a coherent mass. Most preferably, the binder fibers are formed of a thermoplastic polymeric material, such as polyester. Subjecting a preform mat structure of the fibrous filtration media will therefore cause the thermoplastic binder fibers to at least partially melt so that, upon cooling, they will be fused to the glass and synthetic polymer fibers at respective crossing points. One preferred polymeric binder fiber that may be employed successfully in the practice of the present invention is a polyester binder fiber commercially available from MiniFibers, Inc. of Johnson City, Tenn.

Secondary binder fibers may also be present so as to provide at least temporary structural integrity to the fibrous mat during initial drying stages. In this regard, the secondary binder fibers are most preferably at least partially water-soluble at room temperature (20° C). Secondary binder fibers formed of polyvinyl alcohol (PVA), acrylic latex and the like may be employed for such purpose. One type of suitable PVA staple fibers includes Kuralon™VPB 105-2 PVA fibers commercially available from Kuraray Co., Ltd. of Osaka, Japan.

Fibrillated acrylic fibers may also be employed as secondary binder fibers, in which case, the temporary structural integrity is achieved by mechanical interaction with the other fibers in the mat preform sufficient to allow it to be removed from the forming wire.

The binder fibers will most preferably be present in an amount between about 10 to about 20 wt. %, and typically about 15 wt. %. In this regard, if a combination of thermoplastic binder fibers and at least partially water-soluble binder fibers is used, then the former will be present as a major portion of the total amount of binder fibers employed. Thus, for example, the thermoplastic binder fibers may be present in an amount of between about 10 wt. % to about 15 wt. %, preferably about 13 wt. %, while the amount of water-soluble binder fibers may be between about 1 wt. % to about 5 wt. %, preferably about 2 wt. %.

The binder fibers will most preferably have an average fiber diameter of between about 5 to about 25 μ, and more preferably between about 13 to 15 μ, and typically about 10 μ.

The average length of the staple fibers employed in the present invention is not critical. Thus, virtually any staple fiber length may be employed in the practice of the present invention, provided they can be processed into a mat structure (e.g., by wet-laying an aqueous slurry of such fibers). However, average staple fiber lengths will usually be less than about 18 mm, and preferably less about 12 mm. In presently preferred embodiments of the present invention, staple fiber lengths of about 6 mm will be employed.

The accompanying drawing FIGURE schematically depicts the presently preferred process steps for forming filtration media in accordance with the present invention. In this regard, a aqueous mixture or slurry of the synthetic and glass fibers, in addition to the binder fibers if present, is formed in step 10. The aqueous mixture or slurry is then wet-laid onto a forming wire in step 12 using conventional wet sheet-forming techniques. In this regard, step 12 may be practiced using a Fourdrinier or inclined wire wet-laid process or may employ a foam process described more fully in U.S. Pat. No. 5,904,809 (the entire content of which is expressly incorporated hereinto by reference). The dewatered fibrous mat preform will be removed from the forming wire in step 14. During drying, the mat preform is subjected to elevated temperatures sufficient to at least partially plasticize the thermoplastic binder fibers so that upon cooling, adjacent fibers are fused to the plasticized fibers at their respective crossing points. In such a manner, the fibrous mat filtration media of this invention will exhibit satisfactory strength characteristics. The fibrous mat filtration media can then be taken up in step 18, for example, in roll form and subjected to further processing. For example, the fibrous mat may be cut to size and pleated if needed for purpose of forming a filter element.

The thickness of the fibrous mat filter media is not particularly limited. Thus, thicknesses in the range of from about 10 mils to about 50 mils, and typically between about 20 mils to about 30 mils may be formed. The basis weight of preferred fibrous mat filter media of this invention will preferably be between about 20 lbs. to about 75 lbs, and advantageously between about 30 lbs. to about 40 lbs. (“Basis Weight” is the weight in pounds (lbs) per ream of filter media, where each ream consists of 500 sheets of filter media measuring 20 inches wide by 20 inches long.) The fibrous mat filter media will also exhibit an efficacy of at least about 4.0-log reduction, and more preferably at least about 4.5-log reduction, a Wet Burst Strength (2 in. orifice) of at least about 10 inches of water, preferably greater than 50 inches of water, and more preferably at least about 100 inches of water, a Rapidity (2 in. orifice, 6 in. water head) of at least about 175 ml/min, and more preferably at least about 190 mil/min, and a Tensile Strength (machine direction) of greater than about 5 lb/in, and more preferably greater than about 10 lb/in. The filtration media in accordance with the present invention will also most preferably have a mean flow pore (MFP) of less than about 10 microns.

The present invention will be further understood by reference to the following non-limiting Examples.

### EXAMPLES

### Example I

A hand sheet having a mixture of staple fibers as identified below in Table 1A was formed generally in accordance with the process described above and shown schematically in the accompanying FIGURE. The resulting hand sheet was then tested for physical properties using the following methods, and compared with similar data obtained from a 100% glass fiber non-reinforced filtration sheet, and a conventional scrim-reinforced 100% glass fiber filtration sheet (AhIstrom Grade 164). The data appear in Table 1B below.

Test Methods:

FRAZIER Porosity: TAPPI Standard T251 CM-85

RAPIDITY Numbers: The flow rate of water at room temperature (21° C.) through a 2-inch diameter disk of filter material using a water head pressure of 2 inches and 6 inches.

WATER HOLD OUT: The height (in inches) of a 2-inch diameter water column at the point in time where water is forced through a filter media.

WET BURST: The height (in inches) of a 2-inch diameter water column at the point in time where a filter media physically ruptures.

TENSILE STRENGTH: Tensile strength measurements in both the machine direction (MD) and cross-machine direction (CD) were made according to TAPPI Standard T494 OM-88.

EFFICACY: The amount, expressed as −log reduction, of 3.0 micron fluorescing polymer microspheres (Cat. # G0300B, Duke Scientific Corp.) which are removed from 100 ml of a solution containing the same using a Barnstead/Thermolyne Fluorometer.

MEAN FLOW PORE: The mean pore size (microns) of filter media measured with a Beckman Coulter Porometer.

TABLE 1A

| Staple | | | |
|---|---|---|---|
| Fiber | | | |
| Com- | | | |
| ponent | Manufacturer/Source | Amount | |
| Synthetic | Rhodia Performance Fibers, nylon 6,6, .9 dtex | 58.2 | wt. % |
| Glass | JM 106, Johns Manville Micro-Strand ® | 24.3 | wt. % |
| | borosilicate (Type 475) glass microfiber, 0.65 | | |
| | micron BET fiber diameter | | |
| PVA | Kuraray Co., Ltd., KURALON ™ VPB 105-2 | 1.9 | wt. % |
| Binder | polyvinyl alcohol binder fiber | | |
| PBF | Mini Fibers, Inc., polyester binder fiber | 12.6 | wt. % |
| Latex | BF Goodrich, HYCAR ® 26450 acrylic latex | 3.0 | wt. % |

TABLE 1B

| | | | Non- |
|---|---|---|---|
| | Invention | Reinforced | Reinforced |
| | Ex. 1 | Glass | Glass |
| BASIS WEIGHT (lbs; 20 × 20-500) | 36.8 | 40.5 | 21.5 |
| (oz/yd²) | 3.8 | 4.2 | 2.2 |
| THICKNESS (mils) | 28.6 | 25.0 | 16.0 |
| FRAZIER (cfm/ft² @ 0.5″ ΔP) | 7.6 | 2.3 | 3.0 |
| RAPIDITY (ml/mm; 2″ orifice; 2″ waterhead) | 213 | 50 | 60 |
| (ml/mm; 2″ orifice; 6″ waterhead) | 633 | 175 | 220 |
| WATER HOLD OUT (in. H₂O; 2″ orifice) | 5 | not tested | 10 |
| WET BURST (in. H₂O; 2″ orifice) | 144 | not tested | 8 |
| MD TENSILE (lbs/in) | 16.4 | not tested | 4.5 |
| CD TENSILE (lbs/in) | 9.5 | not tested | not tested |
| EFFICACY (-log reduction) | 4.5 | 5.2 | 5.2 |
| MEAN FLOW PORE (microns) | 6.4 | 2.7 | 2.5 |

### Example II

The material in Table 1A above was formed on an open head box, flat wire Fourdrinier paper machine with conventional drum dryers to make a roll of filtration media having the same properties as those noted above in Table 1A. The material formed according to this Example II was also pleated and found to be acceptable.

As the data above demonstrate, the filtration media in accordance with the present invention exhibits substantially improved properties as compared to both non-reinforced and scrim-reinforced 100% glass fiber sheets.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. Fibrous filtration media which includes a mixture of staple glass fibers and synthetic polymeric fibers exhibiting a filtration efficacy of at least about 4.0−log reduction, a wet burst strength of at least about 10-inches inches H₂O , and flow rapidity at a 2-inch waterhead of at least about 175 ml/min.

2. Fibrous filtration media which comprises a mixture of between about 10 to about 50 wt. % glass fibers and between about 25 to about 65 wt. % synthetic polymeric fibers

3. Fibrous filtration media of claim 1 or 2, wherein the synthetic polymeric fibers have an average denier of less than about 3.0.

4. Fibrous filtration media of claim 3, wherein the synthetic polymeric fibers have an average denier of less than about 1.0.

5. Fibrous filtration media of claim 1 or 2, wherein the glass fibers have an average diameter between about 0.20 to about 0.75 μm.

6. Fibrous filtration media according to claim 1 or 2, wherein the synthetic polymeric fibers include at least one type of thermoplastic fibers selected from the group consisting of polyolefin fibers, polyester fibers and polyamide fibers.

7. Fibrous filtration media according to claim 1 or 2, wherein the synthetic polymeric fibers include nylon fibers.

8. Fibrous filtration media according to claim 7, wherein the glass fibers include borosilicate glass fibers.

9. Fibrous filtration media according to claim 8, further comprising between about 10 to about 20 wt. % staple binder fibers.

10. Fibrous filtration media according to claim 1, wherein the synthetic polymeric fibers include nylon fibers.

11. Fibrous filtration media according to claim 1, wherein the glass fibers include borosilicate glass fibers.

12. Fibrous filtration media according to claim 1, further comprising staple binder fibers.

13. Fibrous filtration media according to claim 12, wherein the binder fibers include thermoplastic binder fibers.

14. Fibrous filtration media according to claim 13, wherein the thermoplastic binder fibers are polyester binder fibers.

15. Fibrous filtration media according to claim 12, wherein the binder fibers include at least partially water-soluble binder fibers.

16. Fibrous filtration media according to claim 15, wherein the at least partially water-soluble binder fibers include polyvinyl alcohol fibers.

17. Fibrous filtration media according to claim 12, wherein the binder fibers include a mixture of thermoplastic binder fibers and at least partially water soluble binder fibers.

18. Fibrous filtration media according to claim 17, wherein the thermoplastic binder fibers are present in an amount between about 10 wt. % to about 15 wt. %, and wherein said at least partially water-soluble binder fibers are present in an amount between about 1 wt. % to about 5 wt. %.

19. Fibrous filtration media as in claim 1 or 2 in sheet form.

20. A method of making a fibrous filtration media which comprises (a) the step of wet-laying an aqueous slurry mixture of glass fibers and synthetic fibers onto a foraminous forming member, and (b) dewatering the slurry mixture to form a fibrous dewatered sheet of said glass and synthetic fibers.

21. The method of claim 20, wherein step (a) is practiced by including binder fibers in said aqueous slurry mixture.

22. The method of claim 21, wherein the binder fibers include at least partially water-soluble binder fibers, and wherein step (b) includes allowing the at least partially water soluble binder fibers to at least partially plasticize and thereby bind the glass fibers and synthetic fibers into a coherent mass during dewatering.

23. The method of claim 21 or 22, wherein the binder fibers include thermoplastic binder fibers.

24. The method of claim 23, further comprising after the dewatering step (b), the step of (c) subjecting the fibrous dewatered sheet to elevated temperatures sufficient to at least partially plasticize the thermoplastic binder fibers, and thereafter (d) cooling the sheet to allow the at least partially plasticized thermoplastic binder fibers to resolidify thereby binding the glass and synthetic fibers at respective crossing points.

25. A water filtration process which comprises passing water through a fibrous filtration media according to any one of claims 1-2 or 12-18
